(19) United States
(12) Patent Application Publication
(10) Pub. No.: US 2015/0252860 A1
(43) Pub. Date: Sep. 10, 2015

(54) Positive Displacement Type Clutch System, Power Transfer System Including Positive Displacement Type Clutch And Braking System, And Transmission System Including Multiple Positive Displacement Type Clutch System

(71) Applicant: Jung-Soo Kim, Seoul (KR)

(72) Inventor: Jung-Soo Kim, Seoul (KR)

(21) Appl. No.: 14/637,451

(22) Filed: Mar. 4, 2015

(30) Foreign Application Priority Data
Mar. 4, 2014 (KR) 10-2014-0025607

(51) Int. Cl. F16D 31/00; F16D 67/06; F16H 63/30; F16D 27/00

(52) U.S. Cl. CPC F16D 31/00; F16D 27/004; F16D 67/06; F16H 63/304

(57) ABSTRACT

The positive displacement clutch includes: a clutch disc mounted on an output shaft connected with a load such as a wheel, and having a plurality of vanes arranged with predetermined intervals around its outer side; a clutch casing accommodating the clutch, connected and rotated with an input shaft connected with an engine, and having a plurality of spaces in a cylinder divided by the disc vanes; a piston actuator formed on the clutch casing, rotating with the clutch casing, having a piston roller that comes in contact with the clutch disc, and transmitting rotation of the clutch casing to the clutch disc or not; a magnetic member disposed in the clutch casing and connected with the piston actuator; and a magnetic force generator mounted on an output shaft at a side of the disc casing and operating the piston actuator.

### CROSS REFERENCE TO RELATED APPLICATION(S)

This application claims the benefit of Korean Patent Application No. 10-2014-0025607, filed Mar. 4, 2014, which is hereby incorporated by reference in its entirety into this application.

### BACKGROUND OF THE INVENTION

1. Field of the Invention

The present invention relates to a power transfer system and, more particularly, to a positive displacement clutch using compression resistance in a cylinder that is generated between a piston and a disc vane and vacuum resistance in the cylinder that is generated between the piston and the disc vane, a power transfer system including the positive displacement clutch and a brake, and a transmission system using the positive displacement clutch.

2. Description of the Related Art

In general, machinery using an engine or an electric motor such as a vehicle, a ship, a train, and an industrial machine is equipped with a clutch and a transmission for connecting or disconnecting power and increasing/decreasing torque, and a brake for decelerating and stopping a driving unit that is operated by transmitted power.

First, a clutch transmission used for the machinery changes the number of revolutions and increases/decreases torque from a power generator such as an engine or a motor, but when a load applied to an output shaft is larger than output torque of the output shaft, the load is applied to the motor or the engine generating power, so it reduces the lifespan of the motor or the engine. Further, since the load larger than the output torque of the output shaft is applied to the motor or the engine, desired output cannot be supplied to the output shaft.

Accordingly, due to those problems, a torque converter or a friction clutch transmission that is disposed at various positions such as between a power generator, a driving unit, and a reducer has been developed to solve various problems in power transmission, protect parts, and efficiently shift and transmit power.

A torque converter can achieve smooth shifting and automatic continuous variable shifting, using hydraulic pressure, but, there is inherent slip due to defects of hydraulic pressure and it cases a parasitic loss, so efficiency of the torque converter is reduced, and when load in an engine increases, efficiency of hydraulic power transmission is further reduced, such that power transmission efficiency is further reduced than in a friction clutch transmission.

Further, the friction clutch transmission has been developed and used in various structures, and as typical friction clutch transmissions used for vehicles, an automatic clutch transmission, a manual clutch transmission, and a dual clutch transmission having the convenience of an automatic clutch transmission and efficiency of a manual clutch transmission have been developed and used. In a clutch transmission using friction, the size of a clutch or the number of friction discs is increased in order to increase torque capacity, or compressive pressure is increased by increasing hydraulic pressure or electromagnetic force on a friction clutch. However, it is difficult to increase the size of a clutch or the number of friction discs or unlimitedly increase hydraulic pressure/electromagnetic force in a limited space, as described above, so there is a mechanical limit in increasing torque capacity. As a wheel slips or time passes, the lifespan and performance is decreased by wear of a frictional member and periodic replacement and maintenance of expendable parts may be costly.

On the other hand, as for a brake for reducing or braking a driving unit that is operated by power from a power generator, a brake other than a friction type has not been developed yet, so the existing (hydraulic or frictional) brake generates dust due to wear, generates noise with a small braking force, is damaged at high temperatures, contaminates air due to dispersion of asbestos and metal, and needs to be periodically replaced, so it causes environmental and economical problems.

Therefore, it is required to develop a clutch system that has a long lifespan without environmental pollution due to friction wear by making a brake in a positive displacement type using a volumetric displacement change.

The foregoing is intended merely to aid in the understanding of the background of the present invention, and is not intended to mean that the present invention falls within the purview of the related art that is already known to those skilled in the art.

### SUMMARY OF THE INVENTION

Accordingly, the present invention has been made keeping in mind the above problems occurring in the related art, and the present invention is intended to propose a positive displacement clutch that connects/disconnects power to/from an output shaft from an input shaft, using a volumetric displacement change by moving a piston to a disc and a disc vane in response to an electronic signal.

Further, the present invention provides a power transfer system including a positive displacement clutch and a brake, which generates a braking load using a volumetric displacement change, on one output shaft.

Further, the present invention provides a transmission system using a positive displacement clutch capable of changing a speed of an output shaft in power transmission in response to an electronic signal by making a positive displacement clutch in a dual type or a multistage type.

In order to achieve the above object, according to one aspect of the present invention, there is provided a positive displacement clutch that includes: a clutch disc mounted on an output shaft connected with a load such as a wheel, and having a plurality of disc vanes arranged with predetermined intervals around its outer side; a clutch casing accommodating the clutch, connected and rotated with an input shaft connected with an engine, and having a plurality of spaces in a cylinder divided by the disc vane; a piston actuator formed on the clutch casing, rotating with the clutch casing, having a piston roller that comes in contact with the clutch disc, and transmitting rotation of the clutch casing to the clutch disc or not, using a power transmission load on the clutch disc due to compressive resistance between the piston roller and any one of the disc vanes and vacuum resistance between the piston roller and another one of the disc vanes; and a magnetic member disposed in the clutch casing and connected with the piston actuator; and a magnetic force generator mounted on an output shaft at a side of the disc casing and operating the piston actuator by generating a magnetic force in the clutch casing in cooperation with the magnetic member.

The clutch casing may have a gear teeth structure of a pulley structure around the outer side and may be rotated with the input shaft by a gear engagement structure or a belt connection structure.

The piston actuator may include: a piston cylinder perpendicularly connected with the magnetic member and moved by the magnetic force generator; a piston disposed ahead of the piston cylinder and moved together by the piston cylinder; a piston roller disposed ahead of the piston and rolling on the clutch disc to generate a power transmission load; a piston spring disposed between the piston cylinder and the piston and elastically supporting the piston; a cylinder case combined with the clutch casing and housing the piston cylinder, the piston, the piston roller, and the piston spring; a holder disposed in the cylinder case and defining an oil passage in cooperation with the cylinder case therebetween; and a piston cylinder spring disposed between the piston cylinder and the holder and elastically supporting the piston cylinder.

The piston actuator may be disposed at both sides of the piston casing and rotate the clutch disc by generating a power transmission load using a volumetric displacement change by moving toward a center of the clutch casing so that a pair of piston rollers comes in contact with the clutch disc and the disc vanes.

The magnetic member may be arranged in parallel with the output shaft and perpendicularly connected to the piston actuator, and may move the piston actuator by generating an attractive force or a repulsive force with the magnetic force generator.

The magnetic member may be arranged perpendicular to a driving shaft and connected in parallel to the piston actuator, and may move the piston actuator by generating an attractive force or a repulsive force with the magnetic force generator.

The magnetic force generator may be any one of a permanent magnet or a solenoid coil that has a polarity by an electronic signal.

The positive displacement clutch may further include a magnetic force generator moving member connected with the magnetic force generator and moving the magnetic force generator along the output shaft so that the magnetic force generator is inserted into or drawn out of the clutch casing.

The positive displacement clutch may further include an electrical signal controller applying an electrical signal to the magnetic force generator to give a polarity to the magnetic force generator.

According to another aspect of the present invention, there is provided a power transfer system including a positive displacement clutch and a positive displacement brake. The power transfer system may include: a positive displacement clutch according to an aspect of the present invention; and a positive displacement brake disposed on an output shaft corresponding to the clutch casing of the positive displacement clutch, with the magnetic fore generator therebetween, wherein the positive displacement brake includes: a brake disc disposed on the output shaft and having a plurality of disc vanes arranged with predetermined intervals around its outer side; a brake casing housing the brake disc and having a plurality of sections in a cylinder divided by the disc vanes; a piston actuator including a piston roller that rolls on the brake disc, and decelerating or braking the output shaft by applying a braking load to the brake disc, using compressive resistance between the piston roller and any one of the disc vanes and vacuum resistance between the piston roller and another one of the disc vanes; and a magnetic member disposed in the brake casing, connected with the piston actuator, and operating the piston actuator in cooperation with the magnetic member.

The clutch and the brake may be operated by one magnetic force generator between the clutch and the brake.

According to another aspect of the present invention, there is provided a transmission system for changing a rotational speed of an input shaft connected with a power source into a desired rotational speed of an output shaft. The transmission system may include: a plurality of clutch discs arranged with predetermined intervals on the input shaft and having disc vanes arranged with predetermined intervals on their outer sides; a plurality of clutch casings having different outer diameters, disposed on a driving shaft, housing the clutch discs, respectively, having teeth on their outer side, and having a plurality of sections in cylinders divided by the disc vanes; a plurality of piston actuators formed on the clutch casings, having a piston roller that comes in contact with the clutch discs, and transmitting rotation of the clutch discs to the clutch casings or not, using compressive resistance between the piston rollers and any one of the disc vanes and vacuum resistance between the piston rollers and another one of the disc vanes; a plurality of magnetic members disposed in the clutch casings and connected with the piston actuators; a plurality of magnetic force generators disposed on the driving shaft between adjacent disc casings and operating the piston actuators by generating a magnetic force for acting with the magnetic members in the clutch casings; and a plurality of gears disposed on the output shaft, rolling on the clutch casings, respectively, and having different outer diameters.

The magnetic force generators may be permanent magnets generating a magnetic force or solenoid coils generating a magnetic force by an electrical signal.

According to the present invention, it is possible to remove the problems with existing (hydraulic or frictional) brakes in that they generate dust due to wear, generate noise, are damaged at high temperatures, contaminate air, and needs to be periodically replaced, and it is also possible to achieve environmental-friendly effects of solving air contamination due to frictional wear and increasing the lifespan by transmitting power of a clutch, a power transfer system, and a transmission system, not in a friction type, but in a positive displacement type using a volumetric displacement change.

Further, since the positive displacement clutch uses a volumetric displacement change to connect/disconnect power, it can be used for machinery equipped with a large driving unit such as a train, an airplane, a large ship, and a wind power generator.

Further, since it is possible to use an electrical signal such as a switch by removing complicated mechanical devices in existing clutches, power transfer systems, and transmission systems (using hydraulic pressure and friction), design such as for the position of an operation unit can be freely accomplished.

Further, when it is operated by an electrical signal, a corresponding apparatus is operated upon receiving the electrical signal, so the response is faster and there is not frictional wear, and accordingly, it is possible to perform power transmission, braking, and shifting, in accordance with situations.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a schematic perspective view showing a positive displacement clutch according to an embodiment of the present invention.

FIGS. 2A and 2B are cross-sectional views showing the positive displacement clutch shown in FIG. 1 before it is operated.

FIGS. 3A and 3B are cross-sectional views showing the positive displacement clutch shown in FIG. 1 after it is operated.

FIG. 4 is a cross-sectional view of the positive displacement clutch shown in FIG. 1 before it is operated, in which the magnetic force generator is a permanent magnet.

FIG. 5 is a cross-sectional view of the positive displacement clutch after it is operated, in which the magnetic force generator shown in FIG. 4 is a permanent magnet.

FIG. 6 is a cross-sectional view of the positive displacement clutch shown in FIG. 1 before it is operated, in which the magnetic force generator is a solenoid coil.

FIG. 7 is a cross-sectional view of a positive displacement clutch shown after it is operated, in which the magnetic force generator shown in FIG. 6 is a solenoid coil.

FIG. 8 is a schematic perspective view showing a power transfer system including a positive displacement clutch and a positive displacement brake according to another embodiment of the present invention.

FIG. 9 is a cross-sectional view showing a power transfer system in which the magnetic force generator shown in FIG. 8 is a permanent magnet.

FIG. 10 is a cross-sectional view showing a power transfer system in which the magnetic force generator shown in FIG. 8 is a solenoid coil.

FIGS. 11A to 11D are cross-sectional views illustrating operation of the power transfer system in which the magnetic force generator shown in FIG. 9 is a permanent magnet.

FIGS. 12A to 12D are cross-sectional views illustrating operation of the power transfer system in which the magnetic force generator shown in FIG. 10 is a solenoid coil.

FIG. 13 is a cross-sectional view showing a power transfer system including a positive displacement clutch and a positive displacement brake according to another embodiment of the present invention which is mounted on a vehicle.

FIG. 14 is a perspective view showing a transmission system using a positive displacement clutch according to another embodiment of the present invention.

FIG. 15 is a cross-sectional view showing a transmission system using the positive displacement clutch shown in FIG. 14.

### DETAILED DESCRIPTION OF THE INVENTION

Hereinafter, an embodiment of a positive displacement clutch 100 of the present invention will be described in detail with reference to the drawings.

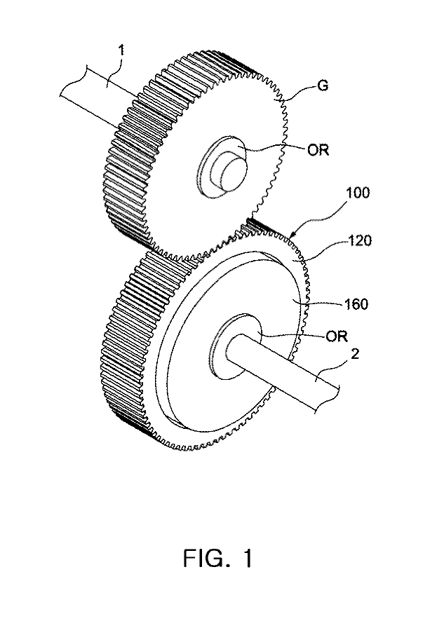

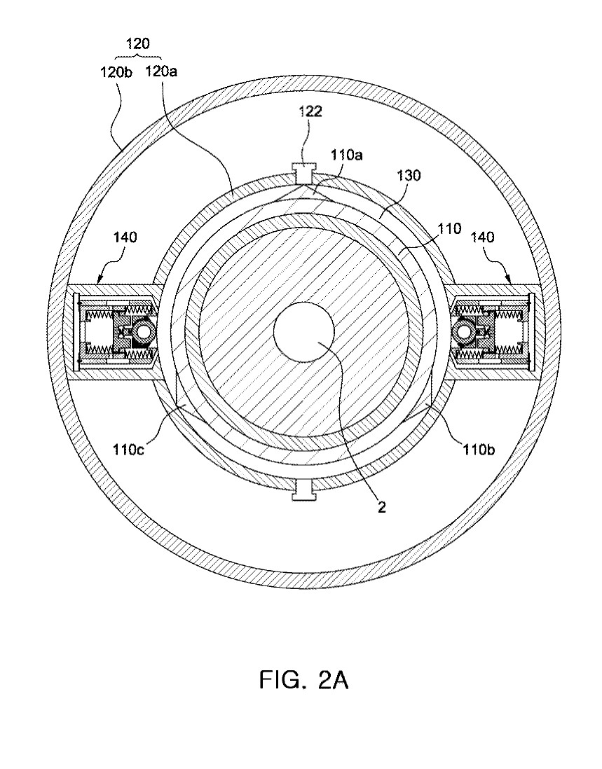

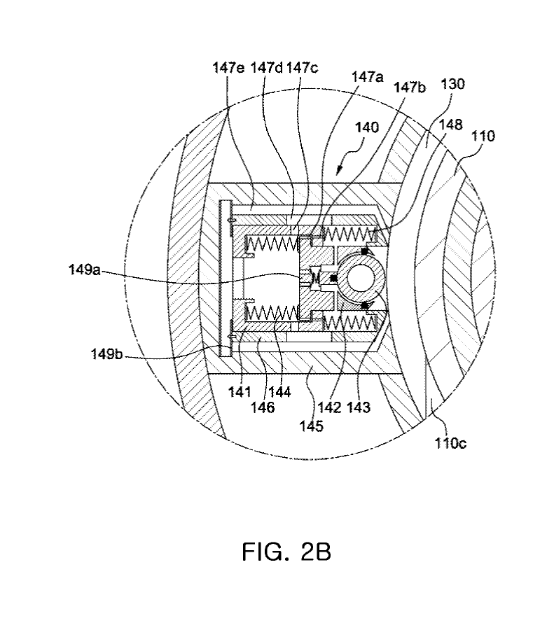

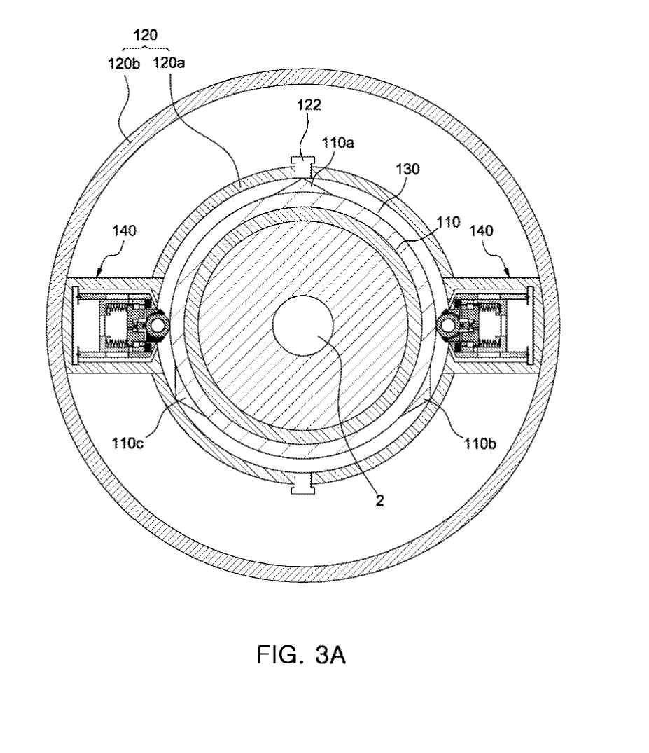

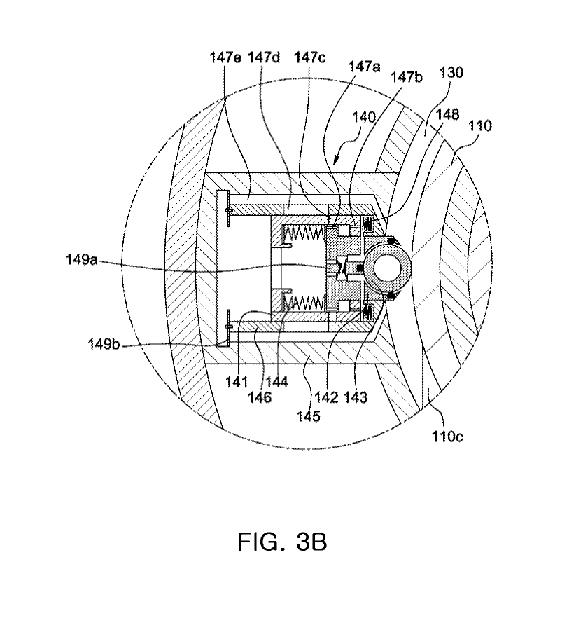

FIG. 1 is a schematic perspective view showing a positive displacement clutch 100 according to an embodiment of the present invention. FIGS. 2A and 2B are cross-sectional views showing the positive displacement clutch 100 shown in FIG. 1 before it is operated. FIGS. 3A and 3B are cross-sectional views showing the positive displacement clutch 100 shown in FIG. 1 after it is operated.

Referring to FIGS. 1 to 3B, the positive displacement clutch 100 of the present invention includes a clutch disc 110 mounted on an output shaft 2 that is connected to a wheel of a vehicle or a train, or a load such as the propeller of a ship, in which the clutch disc 110 has a plurality of disc vanes arranged with a predetermined intervals. The disc vanes are arranged at 120 degrees around the clutch disc 110 to prevent eccentric rotation of the clutch disc 110 and they may be three disc vanes of a first disc valve 110a, a second disc vane 110b, and a third disc vane 110c.

The disc vanes 110a, 110b, and 110c may be formed in the shape of a triangle with respect to the clutch disc 110 so that a piston roller 143 to be described below can smoothly rotate without resistance.

The clutch disc 110 is disposed inside a clutch casing 120 having an inner diameter 120a and an outer diameter 120b and the clutch casing 120 has a gear teeth structure of a pulley structure around the outer side, so it is coupled to an input shaft 1 connected to an engine by a gear G or a belt and rotated by power transmitted from the input shaft 1. In the clutch casing 120, the space inside a cylinder 130 is divided into a plurality of sections by the disc vanes 110a, 110b, and 110c. The cylinder 130 may be filled with a filler, which may be incompressible oil for high power transmission, but oil or various gases, or mixtures of oil and gases may be used in accordance with features of power transfer systems or loads on the systems.

The positive displacement clutch 100 of the present invention further includes a piston actuator 140 having a piston roller 143 rolling on the disc 110, a magnetic member 150 connected with a piston cylinder 141 in the piston actuator 140, and a magnetic force generator 160 disposed on the output shaft 2 at a side of the clutch casing 120 and operating the piston actuator 140 by generating a magnetic force for acting with the magnetic member 150 in the clutch casing 120.

The piston actuator 140 rotates the clutch disc 110 and the output shaft 2 by applying power transmission load, which is caused by compressive pressure resistance between the piston roller 143 and any one of the disc vanes and vacuum resistance between the piston roller 143 and any one of the disc vanes, to the clutch disc 110.

The piston actuator 140 may include: a piston cylinder 141 that is moved by the magnetic force generator 160; a piston 142 that is disposed ahead of the piston cylinder 141 and moved by the piston cylinder 141 together with it; a piston roller 143 that is disposed ahead of the piston 142 and rolls on the clutch disc 110 to generate power transmission load; a piston spring 144 that is disposed between the piston cylinder 141 and the piston 142 and elastically supports the piston 142; a cylinder case 145 that is combined with the clutch casing 120 and houses the piston cylinder 141, the piston 142, the piston roller 143, and the piston spring 144; a holder 146 that is disposed in the cylinder case 145 and defines an oil passage 147e in cooperation with the cylinder case 145 therebetween; and a piston cylinder spring 148 that is disposed between the piston cylinder 141 and the holder 146 and elastically supports the piston cylinder 141. Further, the piston actuator 140 may have an up-down symmetric structure with respect to the piston 142 and may include a plurality of valves and oil passages.

The piston actuator 140 is operated by the magnetic force generator 160, in which two piston rollers 143 roll on the clutch disc 110 and the disc vanes, so a compressive section and a vacuum section are alternately generated in accordance with the rotational direction of the clutch casing 120 and accordingly power transmission is performed by a volumetric displacement change. For example, when the clutch casing 120 rotates clockwise, a compressive section and a vacuum section are formed at the lower portion and the upper portion of the cylinder 130, respectively, so power transmission load is generated, and when the clutch casing 120 rotates counterclockwise, a vacuum section and a compressive section are formed at the lower portion and the upper portion of the cylinder, respectively, so power transmission resistance is generated, thereby performing power transmission using a volumetric displacement change.

Further, the piston 142 presses the clutch disc 110 even in any unstable environments due to external factors such as vibration and shock (a rough road), using a self-energizing action as long as pressure is maintained in the piston cylinder 141, such that power transmission by displacement can be achieved. In detail, in order to maintain power transmission while the clutch casing 120 rotates 360 degrees, a second piston actuator 140 having the same structure of a first piston actuator 140 is disposed at 180 degrees from the first piston actuator 1 so that two pistons are simultaneously operated, and the three disc vanes are arranged at 120 degrees around the clutch disc 110, such that in positive displacement power transmission using compressive and vacuum sections, while the clutch casing 120 rotates 360 degrees, the two pistons 142 perform power transmission, in which even if one of the pistons 142 temporarily loses its power transmission function, the other piston 142 performs power transmission, so power can be continuously transmitted while the clutch casing 120 rotates 360 degrees.

Further, when the piston actuator 140 is operated to transmit power, as the rotational speed of the input shaft 1, that is, the rotational sped of the casing 120 increases, larger pressure and a strong power transmission force proportioned to the pressure are generated in the cylinder 130, so the piston 142 may be equipped with a pressure release valve 143 that prevents damage to the clutch 100 due to compressive pressure and stabilizes design data (speed, maximum load, inertia, and usage) of machinery through simulation.

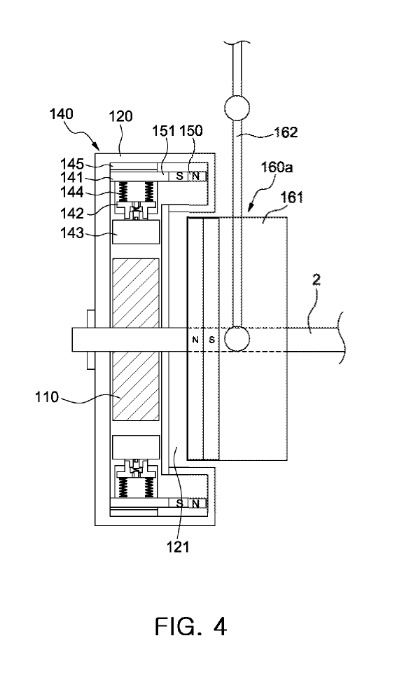

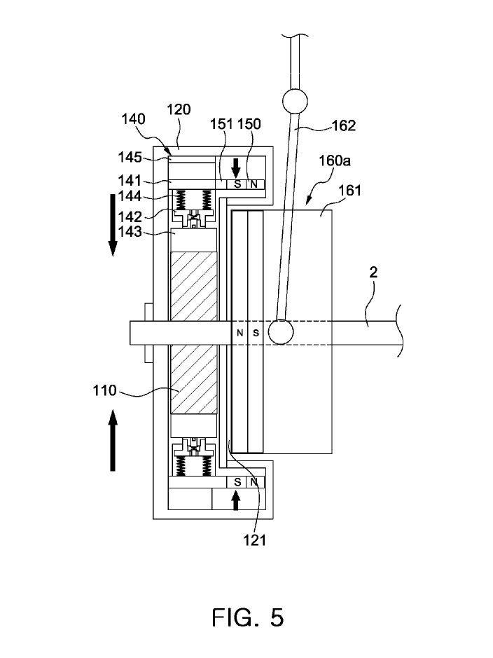

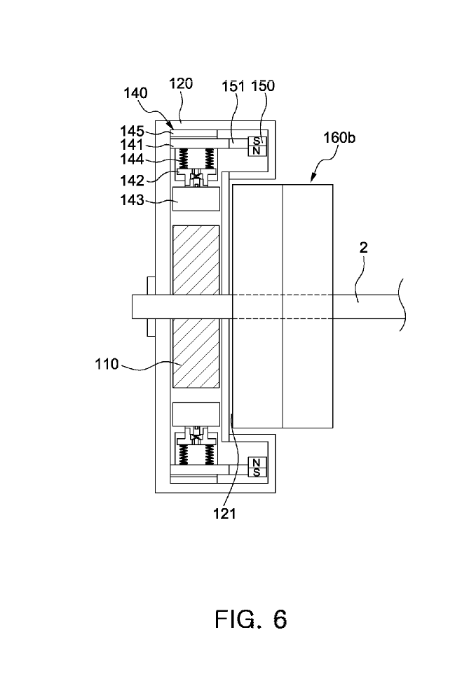

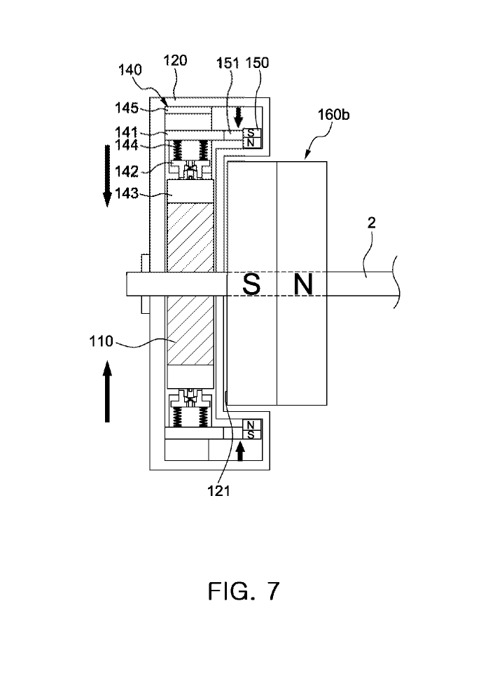

FIG. 4 is a cross-sectional view of the positive displacement clutch 100 shown in FIG. 1 before it is operated, in which the magnetic force generator 160 is a permanent magnet 160a. FIG. 5 is a cross-sectional view of the positive displacement clutch 100 after it is operated, in which the magnetic force generator 160 shown in FIG. 4 is a permanent magnet 160a. FIG. 6 is a cross-sectional view of the positive displacement clutch 100 shown in FIG. 1 before it is operated, in which the magnetic force generator 160 is a solenoid coil 160b. FIG. 7 is a cross-sectional view of a positive displacement clutch shown after it is operated, in which the magnetic force generator 160 shown in FIG. 6 is a solenoid coil 160b.

The magnetic member 150 is connected with the piston actuator 140, in detail, to the piston cylinder 141 of the piston actuator 140. The magnetic member 150 may be connected with the piston cylinder 141 in different types, depending on the shape and type of the magnetic force generator 160, the connection structure between the magnetic member 150 and the piston cylinder 141 will be described below in cases when the magnetic force generator 160 is the permanent magnet 160a and the solenoid coil 160b.

Referring to FIG. 4 first, when the magnetic force generator 160 is a permanent magnet 160a, the permanent magnet 160a may be combined with a permanent magnet holder 161 on the output shaft 2, in which the magnetic member 150 may be perpendicularly connected with the piston cylinder 141 by a connecting rod 151, at a side, with the north pole and the south pole arranged in parallel with the output shaft 2.

In detail, when the magnetic force generator 160 is the permanent magnet 160a, as shown in FIG. 4, the south pole of the magnetic member 150 is perpendicularly connected to the piston cylinder 141 by the connecting rod 151, with the north pole and the south pole arranged in parallel with the output shaft 2. Obviously, the poles of the magnetic member 150 may be arranged in the opposite directions and the pole directions of the magnetic members 150 connected to the two piston cylinders 141 have only to be the same.

On the other hand, as shown in FIG. 6, when the magnetic force generator 160 is a solenoid coil 160b, it is disposed without a specific holder, in which the magnetic member 150 may be connected to the piston cylinder 141 and the connecting rod 151, at a side, with the north pole and the south pole arranged perpendicular to the output shaft 2. In detail, as shown in FIG. 6, a side of the south pole of the magnetic member 151 may be connected in parallel with the piston cylinder 141 by the connecting rod 151, with the north pole and the south pole arranged perpendicular to the output shaft 2. Obviously, similar to the configuration described above, the pole directions of the magnetic members 150 connected to the two piston cylinders 141 have only to be the same. A detailed principle and reason for the arrangement of the of the magnetic members 150 and the connection structure between the magnetic members 150 and the piston cylinders 141 depending on the type of the magnetic force generator 160 will be understood from the following description about the operation of the positive displacement clutch 100.

The magnetic force generator 160, which is provided to move the piston cylinder 141 to an operation position together with the magnetic member 150 by applying an attractive force and a repulsive force to the magnetic member 150 connected to the piston cylinder 141, may have a ring-shaped cross-section, an inner diameter sized to be able to receive the output shaft 2, and an outer diameter sized to be able to be inserted/drawn in/out of a magnetic force generator seat 121 formed on the clutch casing 120. Further, the magnetic force generator 160 may be the permanent magnet 160a or the solenoid coil 160, which were described above.

When the magnetic force generator 160 is the permanent magnet 160a, the poles of the permanent magnet 160a are arranged in parallel with the output shaft 2, the same as the poles of the magnetic member 150, and any one of the poles is inserted in the magnetic force generator seat while applying a repulsive force to any one of the poles of the magnetic member 150.

When the magnetic force generator 160 is the permanent magnet 160a, the inner diameter of the permanent magnet 160a is larger than the diameter of the output shaft 2, so the permanent magnet 160a does not rotate with the output shaft 2, in which a magnetic force generator moving member 162 for moving the permanent magnet 160a further into the magnetic force generator seat 121 along the output shaft 2 may be provided. The magnetic force generator moving member 162 may include any unit that can manually or automatically move the permanent magnet 160a such as a link or a level.

When the magnetic force generator 160 is the solenoid coil 160b, the poles of the solenoid coil 160b changes in accordance with the direction of a current applied to the magnetic force generator 160b, so an electrical signal controller (not shown) may be provided instead of the magnetic force generator moving member, unlike the case when the magnetic force generator 160 is the permanent magnet 160a. Accordingly, when the magnetic force generator 160 is the solenoid coil 160b, it does not need to move, unlike the permanent magnet 160a, so a side of the solenoid coil 160b, that is, a side having any one pole according to an electrical signal keeps deep in the magnetic force generator seat.

The solenoid coil 160b may be mounted on the output shaft 2 not to rotate with the output shaft 2, similar to the permanent magnet 160a, but it may disposed to rotate with the output shaft 2 by applying an electrical signal to the solenoid coil 160b that is rotating.

The operation of the positive displacement clutch 100 described above will be described hereafter with reference to FIGS. 4 to 7.

The operation of the positive displacement clutch 100 to be described hereafter will be separately described in cases when the magnetic force generator 160 is the permanent magnet 160a and the solenoid coil 160b.

1. When the Magnetic Force Generator 160 is the Permanent Magnet 160a

First, as shown in FIG. 4, when the clutch disc 110 is mounted on the output shaft 2 and the clutch casing 120 rotates with the input shaft 1, the magnetic force generator 160 that is the permanent magnet 160a is on the output shaft 2 and maintains a repulsive force with the magnetic member 150 partially inserted in the magnetic force generator seat 121 of the clutch casing 120, with the poles parallel with the output shaft 2. In this state, the piston actuator 140 is not operated and power transmission load is not generated in the cylinder 130, so the clutch disc 110 and the output shaft 2 are not rotated.

Thereafter, when the permanent magnet 160a is moved toward the clutch disc 110, that is, is further inserted into the magnetic force generator seat 121 by operating the magnetic force generator moving member 162, as shown in FIG. 5, if necessary, an attractive force is generated between the permanent magnet 160a and the magnetic member 150 connected with the piston cylinder 141, so the piston cylinder 141 is moved to the operation position toward the clutch disc 110. By allowing oil to flow to the piston 142 and the piston cylinder 141 through an oil passage 147a and an oil passage 147b, respectively, when the piston cylinders 141 are moved to the operation positions by the permanent magnet 160a, resistance due to the difference of oil pressure generated by the piston cylinders 141 moving can be offset.

Further, the pistons 142 are moved with the piston cylinders 141 toward the clutch disc 110 and press the piston springs 144 and the piston cylinder springs 148, so the piston rollers 143 come in contact with the clutch disc 110. As the piston rollers 143 come in contact with the clutch disc 110, a passage 147c of the piston cylinder 141 and a passage 147d of the holder 146 are closed, so the (compressive and vacuum) pressure resistance generated in the cylinder 130 acts as a power transmission load.

In detail, due to the clutch casing 120 rotating clockwise, the disc vane under the piston 142 moves closer to the piston 142, so the volumetric displacement of the cylinder 130 decreases and compressive resistance is generated, while the disc vane above the piston 142 moves away from the piston 142, so the volumetric displacement of the cylinder 130 increases and vacuum resistance is generated.

The compressive pressure in the cylinder 130 under the piston 142 propagates into the piston cylinder 141 through an oil passage 147e in the holder 146 and a one-way check valve 149b, and the compressive pressure that is in proportion to a rotational speed and a volumetric displacement change acts as a force pressing the piston 142 toward the clutch disc 110. Further, the vacuum pressure in the cylinder 130 above the piston 142 acts as a force pulling the piston 142, so the piston 142 can keep pressing the clutch disc 110 even in any unstable environments due to an external factor such as vibration and shock, using a self-energizing action, as long as pressure is maintained in the piston cylinder 141.

As described above, as the pistons 142 in the piston cylinders 141 move, the piston rollers 143 press and roll on the clutch disc 110, and a power transmission load is generated by (compressive/vacuum) pressure resistance due to a volumetric displacement change, when the power transmission load is larger than a resistance limit for rotating the clutch disc 110, the clutch disc 110 rotates with the output shaft 2, so the rotational energy of the input shaft 1 is transmitted to the output shaft, thereby achieving the function of the positive displacement clutch 100.

Thereafter, in order to stop power transmission to the output shaft 2 by the positive displacement clutch 100, when the permanent magnet 160a is partially drawn out of the magnetic force generator seat 121 by the magnetic force generator moving member 162, a repulsive force acts between the magnetic member 150 and the permanent magnet 160a and the piston cylinder 141 is returned to the initial position with the magnetic member 150 by the repulsive force. When the piston cylinder 141 returns to the initial position, a power transmission load is no longer generated and maintained, so power transmission is stopped. The clutch disc 110 and the output shaft 2 to which power is not transmitted any more gradually decelerates without a load, and when the power transmission load that has been generated reduces under the rotational load of the clutch disc 110, the output shaft 2 stops rotating.

2. When the Magnetic Force Generator 160 is the Solenoid Coil 160b.

As shown in FIG. 6 first, the clutch disc 110 is mounted on the output shaft 2 and the clutch casing 120 is connected with the input shaft 1 and rotated. In this state, the magnetic force generator 160 that is the solenoid coil 160b is mounted on the output shaft 2, and unlike the permanent magnet 160a, the solenoid coil 160b is inserted by about ½ in the magnetic force generator seat 160 of the clutch casing 120. Further, an electrical signal is not applied to the solenoid coil 160b, so the solenoid coil 160b does not generate a magnetic force, and force is applied to the piston cylinder 141 toward the outer side (holder) of the clutch casing 120 by the piston spring 144 and the piston cylinder springs 148, such that power transmission resistance is generated in the cylinder and the output shaft 2 is not rotated.

The magnetic member 150 is arranged with the north pole close to the output shaft 2 and the south pole far from the output shaft, so as shown in FIG. 7, a first electrical signal is applied such that a side of the solenoid coil 160b in the magnetic force generator seat 121 becomes the south pole. The side of the solenoid coil 160b that has become the south pole acts an attractive force to the north pole of an adjacent magnetic member 150 and moves to the operation position toward the clutch disc 110 together with the piston cylinder 141.

The entire operation order and action after the piston cylinders 141 are moved to the operation position toward the clutch disc 110 by the solenoid coil 160b are the same as those after the pistons 142 are moved to the operation positions toward the clutch disc 110 by the permanent magnet 160a, so they are not described in detail.

In order to stop power transmission to the output shaft 2 by the positive displacement clutch 100, it may be possible to stop applying the first electrical signal to the solenoid coil 160b or apply a second signal to the solenoid coil 160b. When the second signal is applied to the solenoid coil 160b, opposite to the poles of the solenoid coil receiving the first electrical signal, the side of the solenoid coil 160b that has been the south pole when the first electrical signal is applied becomes the north pole and a repulsive force is generated between the side having the north pole of the solenoid coil 160b and the north pole of the magnetic member 150, so the piston cylinder returns to the initial position together with the magnetic member 150. Thereafter, when the piston cylinder 141 returns to the initial position, the second electrical signal applied to the solenoid coil 160b may be stopped.

Further, when the piston cylinder 141 returns to the initial position, power transmission load is no longer generated and maintained. Thus, the clutch disc 110 and the output shaft 2 that are rotating temporarily decelerate without a load, and then when the power transmission load that has been generated reduces under the rotational load of the clutch disc 110, the output shaft 2 stops rotating.

The positive displacement clutch 100 of the present invention described above has an environmental-friendly effect because it does not cause air pollution due to frictional wear and has a long lifespan.

Further, since the positive displacement clutch 100 uses a volumetric displacement change to connect/disconnect power, it can be used for large machinery such as a train, an airplane, and a large ship.

Further, since the operation of the positive displacement clutch 100 for connecting/disconnecting power can be electronically controlled, operation and connection with other components such as sensor may be easily achieved.

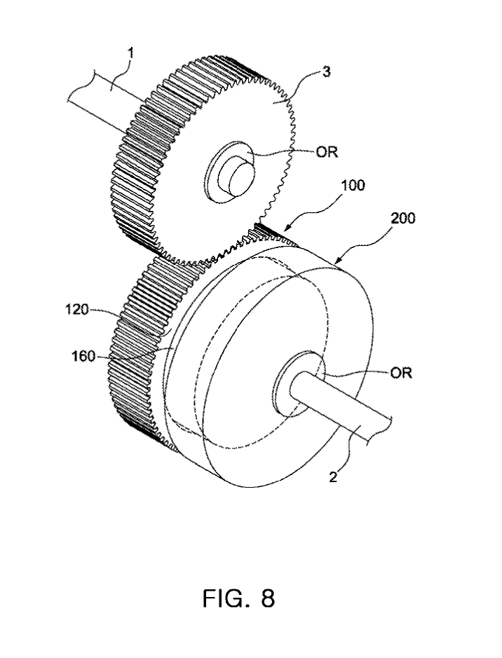

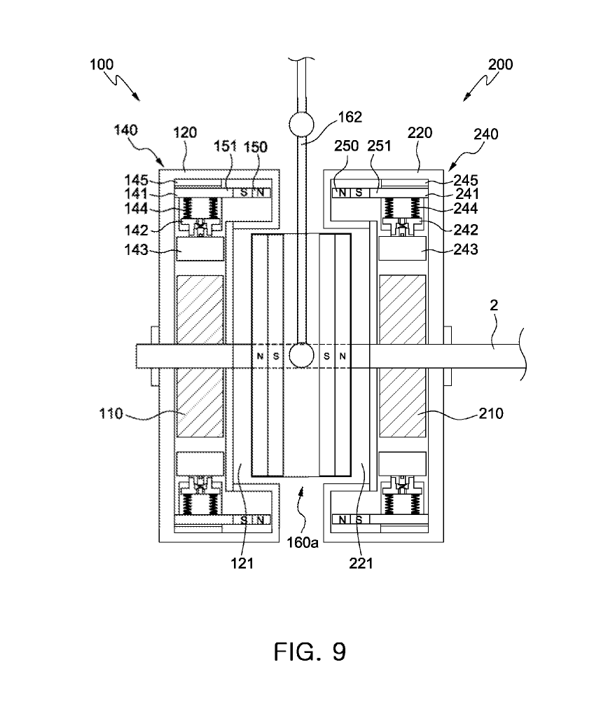

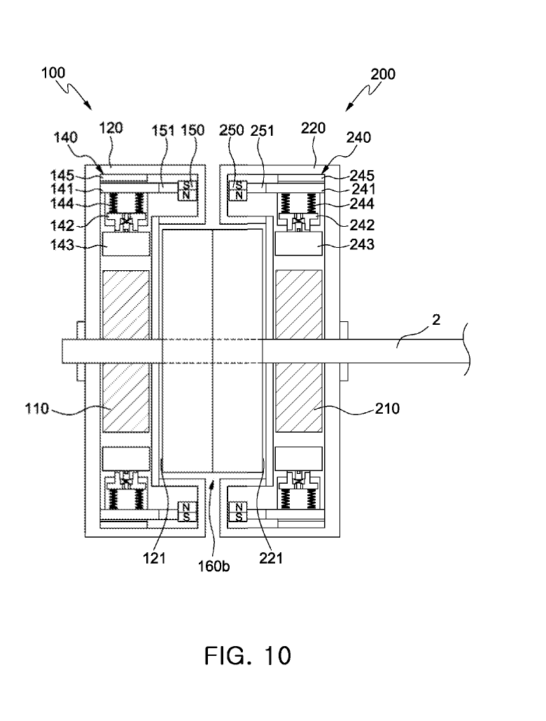

FIG. 8 is a schematic perspective view showing a power transfer system including a positive displacement clutch and a positive displacement brake according to another embodiment of the present invention. FIG. 9 is a cross-sectional view showing a power transfer system in which the magnetic force generator shown in FIG. 8 is a permanent magnet. FIG. 10 is a cross-sectional view showing a power transfer system in which the magnetic force generator shown in FIG. 8 is a solenoid coil.

A power transfer system equipped with a combination of the positive displacement clutch 100 and a positive displacement brake 200 according to another embodiment of the present invention (which is referred to as ‘power transfer system’ hereafter) is described hereafter with reference to FIGS. 8 to 10.

In the power transfer system according to the present invention, the positive displacement clutch 100 and the positive displacement brake 200 are mounted on the output shaft 2, so two parts on a shaft can be controlled as one unit.

In the power transfer system according to the present invention, the positive displacement brake 200 is disposed with the magnetic force generator 160 therebetween on the output shaft 2 mounted with the positive displacement clutch 100, in which other configurations or structures than the positive displacement brake 200 are similar to or the same as those of the previous embodiment, so the same components are given the same reference numerals and the operation of the positive displacement brake 200 and the power transfer system which is not described above is described in detail without detailed description of the positive displacement clutch 100.

The positive displacement brake 200 of the power transfer system according to the present invention, which has a configuration similar to or the same as that of the positive displacement clutch and is provided to decelerate and brake the output shaft 2, includes: a brake disc 210 disposed on the output shaft and having a plurality of disc vanes arranged with predetermined intervals around its outer side; a brake casing 220 housing the brake disc 210 and having a plurality of sections in a cylinder 230 divided by the disc vanes; a piston actuator 240 including a piston roller 243 that rolls on the brake disc 210 and decelerating or braking the output shaft by applying braking load to the brake disc 210, using compressive resistance between the piston roller 243 and any one of the disc vanes and vacuum resistance between the piston roller 243 and another one of the disc vanes; and a magnetic member 250 disposed in the brake casing 220, connected with the piston actuator 240, and operating the piston actuator 240 in cooperation with the magnetic member 250.

The configuration and structure of the positive displacement brake 200 are similar to/the same as the configuration and structure corresponding to the components of the clutch 100 and the piston actuator 240 of the positive displacement brake 200 may be disposed between the clutch 100 and the positive displacement brake 200 and operated by one magnetic force generator 160.

However, unlike the configuration in which the clutch casing 220 is rotated with the input shaft 1, it is stopped (fixed) without rotating with another component in the positive displacement brake 200.

Further, the positive displacement brake 200 is different in that it stops the brake disc 210 and the output shaft 2 for braking by using, as a braking load, (compressive and vacuum) pressure in the cylinder 130 of the brake 200, which is generated in the opposite principle to the power transmission load generated in the cylinder 130 of the positive displacement clutch 100 when the piston cylinders 241 of the piston actuator 240 are moved to operation positions toward the brake disc 210 by the magnetic force generator 160. That is, the piston cylinders 241 of the brake 200 are moved to the operation positions toward the brake disc 210 by the magnetic force generator 160 and two piston rollers 243 come in contact with the brake disc 210 and the disc vanes by the movement of the piston cylinders 241, such that compressive pressure and vacuum pressure are generated at the upper portion and the lower portion of the cylinder 230, respectively, when the brake disc 210 rotates clockwise, while vacuum pressure and compressive pressure are generated at the upper portion and the lower portion of the cylinder 230 when the brake disc 210 rotates counterclockwise, thereby generating braking load.

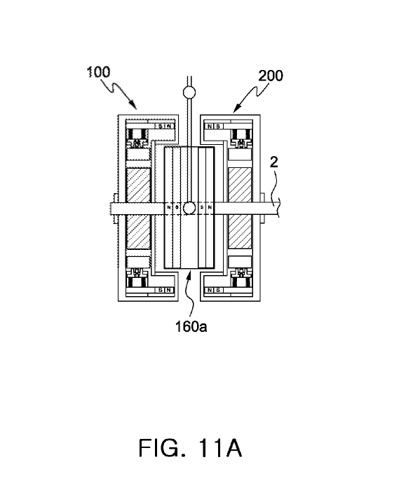

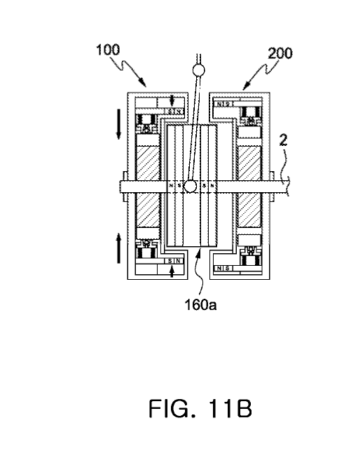

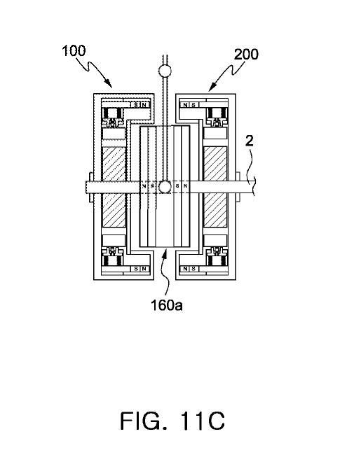

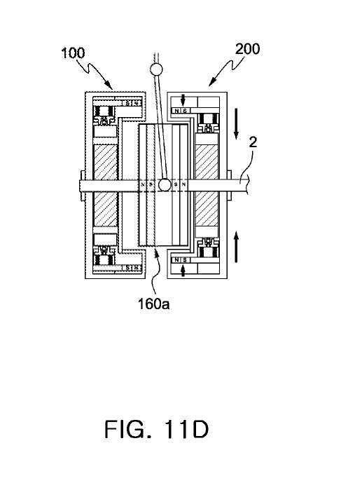

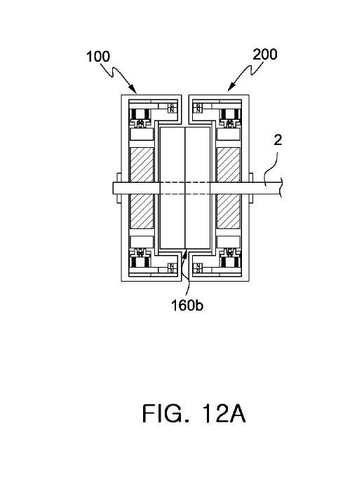

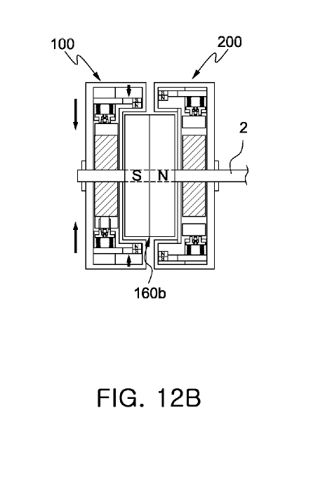

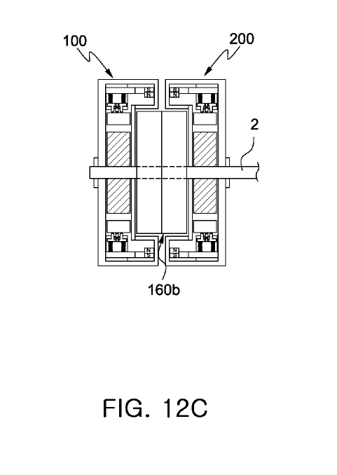

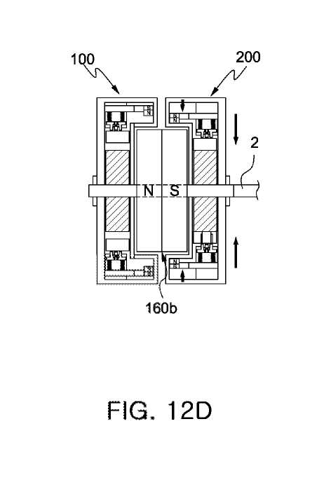

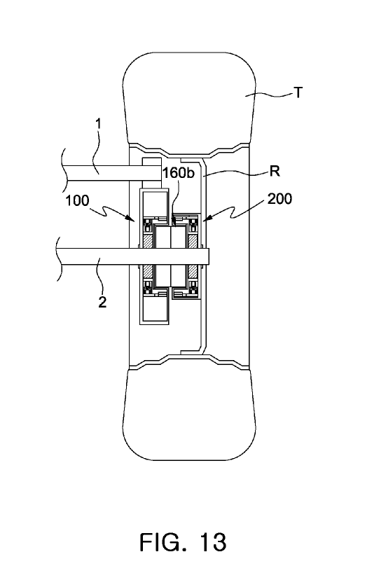

FIGS. 11A to 11D are cross-sectional views illustrating operation of the power transfer system in which the magnetic force generator shown in FIG. 9 is a permanent magnet. FIGS. 12A to 12D are cross-sectional views illustrating operation of the power transfer system in which the magnetic force generator shown in FIG. 10 is a solenoid coil.

Hereinafter, the operation of the power transfer system according to the present invention is described. The operation of the power transfer system of the present invention may be divided in the cases when the magnetic force generator 160 is the permanent magnet 160a and when the magnetic force generator 160 is the solenoid coil 160b. Further, the operation may be divided into three types of a non-load state depending on whether a power transmission load (compressive/vacuum pressure) or braking load (compressive/vacuum pressure) that is generated by the operation of the system is generated or not (positive displacement clutch 100 OFF/positive displacement brake 200 OFF), a power transmission state (positive displacement clutch 100 ON/positive displacement brake 200 OFF), and a braking state (positive displacement clutch 100 OFF/positive displacement brake 200 ON).

First, the operation when the magnetic force generator 160 is the permanent magnet 160a is described with reference to FIGS. 11A to 11D.

1. When the Magnetic Force Generator 160 is the Permanent Magnet 160a

1-1 Non-Load State (Initial State and Neutral State: Positive Displacement Clutch 100 OFF/Positive Displacement Brake 200 OFF)

First, as shown in FIG. 11A, in the non-load state that is the initial state without the output shaft 2 rotating, the clutch casing 120 of the positive displacement clutch 100 rotates with a driving shaft and the magnetic force generator 160 that is the permanent magnet 160a is arranged with one pole in the magnetic force generator seats 121 and 221 of the clutch 100 and the brake 200.

In this state, the magnetic members 150 and 250 of the positive displacement clutch 100 and the positive displacement brake 200 act a repulsive force to the magnetic force generator 160, so without the piston cylinders 141 and 241 actuated, the positive displacement 100 performs the power transmission function with power transmission load and the positive displacement brake 200 performs the braking function with braking load.

1-2 Power Transmission State (Positive Displacement Clutch 100 ON/Positive Displacement Brake 200 OFF)

Torque from the input shaft 1 should pass through the clutch 100 in order to be transmitted to the output shaft 2 and the magnetic force generator 160 is fully inserted into the magnetic force generator seat 121 by the magnetic force generator moving member 162, as shown in FIG. 11B, to operate the piston actuator 140 of the clutch 100.

When the magnetic force generator 160 is fully inserted in the magnetic force generator seat 121 of the positive displacement clutch 100, an attractive force is generated between the magnetic force generator 160 and the magnetic member 150 of the positive displacement clutch 100, so the magnetic member 150 is moved toward the clutch disc 110. Accordingly, the piston actuator 140 of the positive displacement clutch 100 which is connected to the magnetic member 150 is moved to an operation position toward the clutch disc 110 and the piston roller 143 comes in contact with the clutch disc 110 and the disc vane. In this process, a power transmission load (compressive/vacuum pressure) is generated in the cylinder 130 of the positive displacement clutch 100 and rotates the output shaft 2 with the clutch disc 110 (transmits power).

The magnetic member 250 of the positive displacement brake 200 keeps a repulsive force with respect to the magnetic force generator 160 and the piston actuator 240 of the positive displacement brake 200 is not operated, such that a braking load cannot be generated.

1-3. Braking State (Positive Displacement Clutch 100 OFF/Positive Displacement Brake 200 ON)

It is required to operate the positive displacement brake 200 in order to decelerate or brake the output shaft 2 rotated by the power transmitted through the positive displacement clutch 100, in which it is required to move the magnetic force generator to the magnetic force generator seat 221 of the positive displacement brake 200, using the magnetic force generator moving member 162.

The magnetic force generator 160 close to the positive displacement clutch 100 is moved to the positive displacement brake 200 through the position of the non-load state (positive displacement clutch 100 OFF/positive displacement brake 200 OFF), as shown in FIG. 11C. This is for preventing the power transmission by the positive displacement clutch 100 and the braking by the positive displacement brake 200 from overlapping each other. That is, when power transmission and braking are simultaneously performed (positive displacement clutch 100 ON/positive displacement brake 200 ON), a large load is applied to a power source of the rotary shafts 1 and 2 and the system may be damaged, so it is preferable to pass through the non-load state in order to switch the positive displacement clutch 100 and the positive displacement brake 200.

The magnetic force generator 160 is moved to the position of the non-load state by the magnetic force generator moving member 162 and the magnetic member 150 of the positive displacement clutch 100 acts a repulsive force to the magnetic force generator 160, so that the piston actuator 140 is moved toward the clutch casing 120. Accordingly, power transmission load is no longer generated in the cylinder 130 of the positive displacement clutch 100 and the output shaft 2 enters the non-load state.

Thereafter, the magnetic force generator 160 is moved to be fully inserted into the magnetic force generator seat 221 of the brake 220 by the magnetic force generator moving member 162, as shown in FIG. 11D.

When the magnetic force generator 160 is fully inserted in the magnetic force generator seat 221 of the positive displacement brake 200, an attractive force is generated between the magnetic force generator 160 and the magnetic member 250 of the positive displacement brake 200, so the magnetic member 250 is moved to an operation position toward the clutch disc 210. Accordingly, the piston actuator 240 of the positive displacement brake 200 that is connected to the magnetic member 250 is moved to an operation position and the piston roller 243 comes in contact with the brake disc 210 and the disc vane. Therefore, a braking load is generated in the cylinder 230 of the positive displacement brake 200, so the output shaft 2 is decelerated and stopped.

The operation when the magnetic force generator 160 is the solenoid coil 160b is described hereafter with reference to FIGS. 12A to 12D.

2. When the Magnetic Force Generator 160 is the Solenoid Coil 160b.

2-1 Non-Load State (Initial State or Neutral State: Positive Displacement Clutch 100 OFF/Positive Displacement Brake Assembly 200 OFF)

First, as shown in FIG. 12A, in the non-load state that is the initial state without the output shaft 2 rotating, the clutch casing 120 of the positive displacement clutch 100 rotates with the input shaft 1 and the magnetic force generator 160 that is the solenoid coil 160b is partially in both of the magnetic force generator seats 121 and 221 of the positive displacement clutch 100 and the positive displacement brake 200. Further, no electrical signal is applied to the solenoid coil 160b. Further, the magnetic members 150 and 250 of the two devices are arranged perpendicular to the output shaft 2, with the north poles close to the output shaft 2 and the south poles far from the output shaft 2.

In the non-load state, since the solenoid coil 160b does not have a magnetic force, it does not generate an attractive force or a repulsive force with the magnetic members 150 and 250 of the positive displacement clutch 100 and the positive displacement brake 200. Further, the solenoid coil 160b is at the initial position by the elastic force of the piston springs 144 and 244 and the piston cylinder springs 148 and 248, and the piston actuators 140 and 240 are not operated. Therefore, the positive displacement clutch 100 does not perform the power transmission function with a power transmission load and the positive displacement brake 200 does not perform the braking function with a braking load.

2-2. Power Transmission State (Positive Displacement Clutch 100 ON/Positive Displacement Brake 200 OFF)

Torque from the input shaft 1 has to pass through the clutch 100 in order to be transmitted to the output shaft 2 and it is required to make the solenoid coil 160 a magnetic body by applying a first electric signal in order to operate the piston actuator 140 of the clutch 100. By the first electrical signal applied to the solenoid coil 160b, the electrode of the solenoid coil 160b that is close to the clutch 100 becomes the south pole and the electrode of the solenoid coil 160b that is close to the positive displacement brake 200 becomes the north pole, as shown in FIG. 12B.

Accordingly, as the first electrical signal is applied to the solenoid coil 160b, an attractive force is generated between the magnetic member 150 and the solenoid coil 160b close to the clutch 100 and the magnetic member 150 of the clutch 100 is moved toward the clutch disc 110 by the attractive force, such that the piston actuator 140 of the clutch 100 that is connected with the magnetic member 150 is operated toward the clutch disc 110 and the piston clutch comes in contact with the clutch disc 110 and the disc vane.

Therefore, a power transmission load is generated in the cylinder 130 of the clutch 100 and rotates the output shaft 2 with the clutch disc 110 (transmits power).

On the other hand, the side of the solenoid coil 160b that is close to the positive displacement brake 200 is given the north polarity by the first electrical signal and generates and keeps a repulsive force with respect to the magnetic member 250 of the positive displacement brake 200. Therefore, the piston actuator 240 of the positive displacement brake 200 is not moved to an operation position and cannot generate a braking load.

2-3. Braking State (Positive Displacement Clutch 100 OFF/Positive Displacement Brake 200 ON)

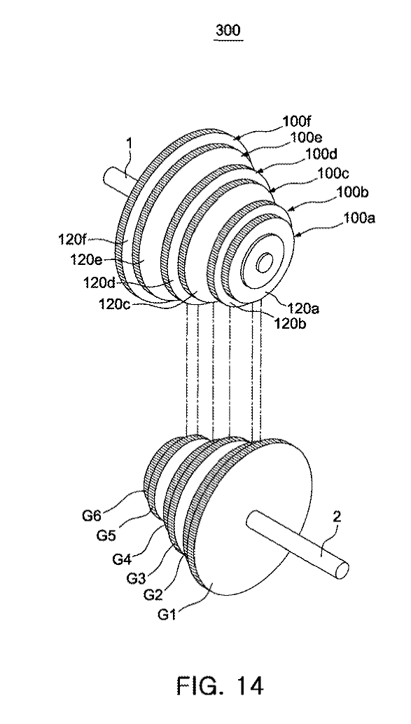

It is required to operate the positive displacement brake 200 in order to decelerate or brake the output shaft rotated by the power transmitted through the positive displacement clutch 100, and for this purpose, it is required to apply a second electrical signal to the solenoid coil 160b to generate an attractive force between the solenoid coil 160b close to the brake 200 and the magnetic member 250 of the positive displacement brake 200. By the electrical signal, as shown in FIG. 14D, the electrode of the solenoid coil 160b that is close to the positive displacement clutch 100 becomes the north pole and the electrode of the solenoid coil 160b that is close to the positive displacement brake 200 becomes the south pole.

When the positive displacement brake 200 is operated by applying the second electrical signal to the solenoid coil 160b, as described above, it is required to temporarily block the first electrical signal that has been applied to the solenoid coil 160b, as shown in FIG. 12C before applying the second electrical signal for changing the direction of the current in the solenoid coil 160b, and then apply the second electrical signal. In this process, the reason of not applying the second electrical signal right after applying the first electrical signal, but applying the second electrical signal after temporarily blocking the electrical signal that has been applied is for preventing overlap of power transmission by the positive displacement clutch 100 and braking by the positive displacement brake 200.

When the second electrical signal is applied to the solenoid coil 160b, the electrode of the solenoid coil 160b that is close to the positive displacement clutch 100 becomes the north pole and the electrode of the solenoid coil 160b that is close the positive displacement brake 200 becomes the south pole, such that the solenoid coil 160b acts a repulsive force to the magnetic member 150 of the positive displacement clutch 100, such that the piston actuator 140 is moved toward the clutch casing 120, a power transmission load is no longer generated in the cylinder 130 of the positive displacement clutch 100, and the output shaft 2 enters the non-load state.

In contrast, an attractive force is generated between the solenoid coil 160b and the magnetic member 250 of the positive displacement brake 200 and the magnetic member 250 is moved toward the brake disc 210 by the attractive force, so that the piston actuator 240 of the positive displacement brake 200 that is connected with the magnetic member 250 is operated toward the brake disc 210 and the piston roller 243 comes in contact with the brake disc 210 and the disc vane. Therefore, a braking load is generated in the cylinder 230 of the positive displacement brake 200, so the output shaft 2 is decelerated and stopped.

The power transfer system of the present invention described above may be achieved in a single module or may be achieved in a compact power transfer module with two parts facing each other on one shaft.

Further, when the power transfer system according to the present invention operates to transmit power or brake, the power transmission state and the braking state do not interfere with each other.

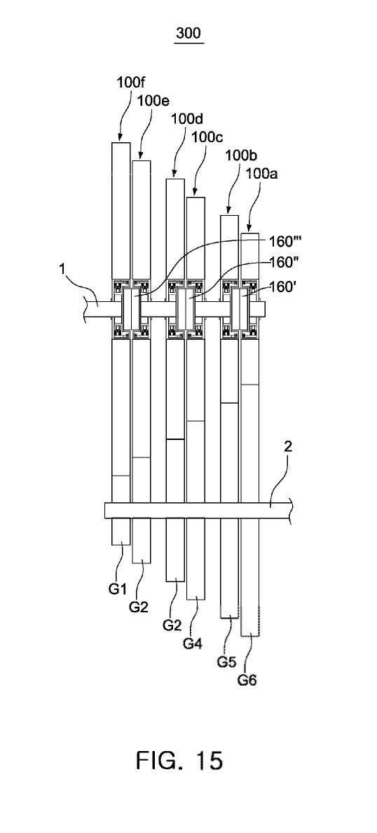

FIG. 14 is a perspective view showing a transmission system using a positive displacement clutch according to another embodiment of the present invention. FIG. 15 is a cross-sectional view showing a transmission system using the positive displacement clutch shown in FIG. 14.

A transmission system using the positive displacement clutch 100 according to another embodiment of the present invention is described hereafter with reference to FIGS. 14 and 15. The configuration corresponding to the positive displacement clutch 100 according the previous embodiments is similar or the same in the present embodiment, so the same components are given the same reference numerals and the similar or the same configuration is not described in detail.

A transmission system using the positive displacement clutch 100 according to the present invention (hereafter, referred to as a ‘transmission system’) is a system for converting a rotational speed of the input shaft 1 connected to a power source such as an engine into a rotational speed of the output shaft 2, in which a positive displacement clutch having a plurality of different gear ratios is mounted on the input shaft 1 and a plurality of gears that come in contact with the positive displacement clutch 100 is mounted on the output shaft 2 so that shifting can be achieved by control based on a magnetic force.

Referring to FIGS. 14 and 15, the transmission system of the present invention includes a plurality of clutch discs 110 on the input shaft 1, a plurality of clutch casings 120 housing the clutch discs 110, having teeth around the outer side, and having a plurality of spaces in a cylinder divided by disc vanes, a plurality of piston actuators 130 formed on the clutch casings 120, a plurality of magnetic members 150 disposed in the clutch casings 120 and connected with the piston actuators 140, and a plurality of magnetic force generators 160 operating the piston actuators 140 by generating a magnetic force for acting with the magnetic members 150 in the clutch casings 120.

The clutch discs 110, clutch casings 120, piston actuators 140, magnetic members 150, and magnetic force generators 160 may be similar to or the same as those of the positive displacement clutch 100 described above.

However, in the clutches 100a to 100f of the transmission system, the outer diameters of the adjacent clutch casings 120a to 120f may be different. That is, the clutch casings 120a to 120f with the teeth have different outer diameters so that their gear ratios are different.

Further, two magnetic force generators 160 are disposed in a set between the clutch casings 120a to 120f.

According to this structure, the steps of shifting can be defined as much as the number of the clutches 100a to 100f, and it is exemplified in the present invention for the convenience of description that six clutches 100a to 100f are provided, as shown in FIG. 14, so six-step shifting can be achieved.

Gears G1 to G6 being in contact with the clutch casings 120a to 120f and having different outer diameters, that is, different gear ratios, are disposed on the output shaft 2 in a number equal to the number of the clutch casings 120a to 120f. That is, as shown in FIG. 15, when there are six clutches 100 are provided, six gears are provided.

In the transmission system having the configuration described above in accordance with the present invention, pairs of the clutches 100a to 100f are each operated (controlled) by one magnetic force generator 160, and three magnetic force generators 160′, 160″, and 160′″ may be provided for six-stage shifting.

Shifting by the transmission system of the present invention is described hereafter. In the transmission system according to the present invention, a pair of clutches is controlled by one magnetic force generator 160 and power is transmitted, and shifting (shifting to the second stage to the first stage) by a pair of clutches 100a and 100b at the right side in FIG. 15 is exemplified.

Further, there are some differences in additional configuration and operation of the magnetic force generator 160 due to a permanent magnet 160a and a solenoid coil 160b, but those differences can be understood (explained) by the above description of the operation of the clutch 100, so the entire operation of the transmission system of the present invention is described hereafter by exemplifying a case when the magnetic force generator 160 is a solenoid coil 160b.

1. Neutral State (First and Second Positive Displacement Clutches 100a and 100b: OFF)

In the neutral state without rotation of the input shaft 1 transmitted to the output shaft 2, no electrical signal is supplied to a solenoid coil 160b′.

In detail, the first and second clutches 100a and 100b on the input shaft 1 are supplied with rotational energy from a power source, so they rotate with the input shaft 1, but piston cylinders 141a and 141b of piston actuators 140a and 140b, which are operated by elastic forces of piston springs 144a and 144b and piston cylinder springs 148a and 148b and interaction (repulsive force) between magnetic members 150a and 150b, are not operated yet, so (compressive/vacuum) pressure is not generated in cylinders 130a and 130b of the first and second clutches 100a and 100b and clutch casings 120a and 120b are not rotated.

Therefore, since the clutch casing 120a and 120b being in contact with the gears G1 and G2 on the output shaft 2 are not rotated, power is not transmitted to the output shaft 2, which is a neutral (non-power) state.

2. Shifting to First Stage (First Positive Displacement Clutch 100a: ON/Second Positive Displacement Clutch 100b: OFF)

In operation of the first positive displacement clutch 100a for shifting to the first stage, when the magnetic member 150a of the first positive displacement clutch 100a applies a first electrical signal in the direction in which it generates an attractive force with the solenoid coil 160b′, the piston actuator 140a of the first positive displacement clutch 100a is operated by the attractive force between the magnetic member 150a of the first positive displacement clutch 100a and the solenoid coil 160b′ and the piston cylinder 141a moves to an operation position toward the clutch disc 110a while pressing the piston spring 144a and the piston cylinder spring 148a. Further, when the piston cylinder 141a is moved to the operation position, the piston roller 143a comes in contact with the clutch disc 110a so a power transmission load (compressive/vacuum pressure) is generated in the cylinder 130a.

Accordingly, the clutch casing 120a is rotated with the clutch disc 110a by the power transmission load in the cylinder 130a and the output shaft 2 is rotated with the gear G1, such that rotation (power) of the input shaft 1 is transmitted to the output shaft 2 by the first positive displacement clutch 100a.

On the other hand, when the first electrical signal is applied to the solenoid coil 160b′, the side of the solenoid coil 160b′ that is close to the second positive displacement clutch 100b generates a repulsive force against the magnetic member 150b of the second positive displacement clutch 100b, so the piston actuator 140b cannot move to the operation position. Accordingly, power transmission load (compressive/vacuum pressure) is not generated in the cylinder 130b between the clutch disc 110b and the clutch casing 120b of the second positive displacement clutch 100b, so that the clutch casing 120b of the second positive displacement clutch 100b is not rotated. The second clutch 100b stands by for the next step (shifting to the second stage).

3. Shifting to Second Stage (First and Second Positive Displacement Clutch 100a and 100b: OFF→First Positive Displacement Clutch 100: OFF, Second Positive Displacement Clutch 100b: ON)

Similarly in the operation of the second positive displacement clutch 100b, in order to change the current direction in the solenoid coil 160b′ so that the interactive magnetic force between the solenoid coil 160b′ and the magnetic member 150b of the second positive displacement clutch 100b becomes an attractive force, it is required to apply a second signal, after making a neutral state by temporarily blocking the first electrical signal that has been applied to the solenoid coil 160b′.

The reason of temporarily making a neutral state by blocking the first electrical signal that has been applied to the solenoid coil 160b′ before applying the second electrical signal is, as described above in connection with the previous embodiment, for preventing overlap between power transmission by the first positive displacement clutch 100a and power transmission by the second positive displacement clutch 100b.

When the second electrical signal is applied to the solenoid coil 160b′, an attractive force is generated between the magnetic member 150b of the second positive displacement clutch 100b and the solenoid coil 160b′ and the piston actuator 140b of the second positive displacement clutch 100b is operated, so that the piston cylinder 141b moves to the operation position toward the clutch disc 110b while pressing the piston spring 144b and the piston cylinder spring 148b.

Thereafter, a power transmission load is generated in the cylinder 130b of the second positive displacement clutch 100b and the clutch casing 120b of the second positive displacement clutch 100b is rotated by the power transmission load, so the output shaft 2 is rotated by the gear G2 being in contact with the clutch casing 120b of the second positive displacement clutch 100b.

On the other hand, when the second electrical signal is applied to the solenoid coil 160b′, the side of the solenoid coil 160b′ that is close to the first positive displacement clutch 100a generates a repulsive force against the magnetic member 150a of the first positive displacement clutch 100a, so the piston actuator 140a is moved and fixed at the initial position. In this process, the piston cylinder 141a of the first positive displacement clutch 100a enters the neutral state with the first electrical signal that has been applied to the solenoid coil 160b′ blocked, and it returned to the initial position by the piston spring 144a and the piston cylinder spring 148a. Accordingly, a power transmission load (compressive/vacuum pressure) is no longer generated in the cylinder 130a between the first clutch casing 120a and the clutch disc 110a, so a non-power state in which power is not transmitted between the first positive displacement clutch 100a and the output shaft 2 is formed.

Further, for the operation (shifting to the third stage) of the third positive displacement clutch 100c, as in the order described above, it is possible to shift to the third sage by applying a first electrical signal to the solenoid coil 160b″ between the third and fourth positive displacement clutch 100c and 100d after putting the solenoid coil 160b′ between the first and second positive displacement clutch 100a and 100b into the neutral state.

The transmission system of the present invention described above may be achieved in a single module or may be achieved by a pair of two modules facing each other on one shaft, so the number of modules can be increased, if necessary.

Further, in the transmission system according to the present invention, since the positive displacement clutch for the next step is operated with the previous positive displacement clutch stopped in shifting, there is no interference between clutches.

Further the transmission system according to the present invention can be applied to or replace existing dual clutches used in vehicles, so the automotive industry can be technically developed.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A positive displacement clutch comprising:
a clutch disc mounted on an output shaft connected with a load such as a wheel, and having a plurality of disc vanes arranged with predetermined intervals around its outer side;
a clutch casing accommodating the clutch, connected and rotated with an input shaft connected with an engine, and having a plurality of spaces in a cylinder divided by the disc vanes;
a piston actuator formed on the clutch casing, rotating with the clutch casing, having a piston roller that comes in contact with the clutch disc, and transmitting rotation of the clutch casing to the clutch disc or not, using a power transmission load on the clutch disc due to compressive resistance between the piston roller and any one of the disc vanes and vacuum resistance between the piston roller and another one of the disc vanes;
a magnetic member disposed in the clutch casing and connected with the piston actuator; and
a magnetic force generator mounted on the output shaft at a side of the disc casing and operating the piston actuator by generating a magnetic force in the clutch casing in cooperation with the magnetic member.

2. The positive displacement clutch of claim 1, wherein the clutch casing has a gear teeth structure or a pulley structure around the outer side and is rotated with the input shaft by a gear engagement structure or a belt connection structure.

3. The positive displacement clutch of claim 1, wherein the piston actuator includes:
a piston cylinder perpendicularly connected with the magnetic member and moved by the magnetic force generator;
a piston disposed ahead of the piston cylinder and moved together by the piston cylinder;
a piston roller disposed ahead of the piston and rolling on the clutch disc to generate a power transmission load;
a piston spring disposed between the piston cylinder and the piston and elastically supporting the piston;
a cylinder case combined with the clutch casing and housing the piston cylinder, the piston, the piston roller, and the piston spring;
a holder disposed in the cylinder case and defining an oil passage in cooperation with the cylinder case therebetween; and
a piston cylinder spring disposed between the piston cylinder and the holder and elastically supporting the piston cylinder.

4. The positive displacement clutch of claim 2, wherein the piston actuator is disposed at both sides of the piston casing and is rotated the clutch disc by generating a power transmission load using a volumetric displacement change by moving toward a center of the clutch casing so that a pair of piston rollers comes in contact with the clutch disc and the disc vanes.

5. The positive displacement clutch of claim 1, wherein the magnetic member is arranged in parallel with the output shaft and perpendicularly connected to the piston actuator, and is moved the piston actuator by generating an attractive force or a repulsive force with the magnetic force generator.

6. The positive displacement clutch of claim 1, wherein the magnetic member is arranged perpendicular to a driving shaft and connected in parallel to the piston actuator, and is moved the piston actuator by generating an attractive force or a repulsive force with the magnetic force generator.

7. The positive displacement clutch of claim 1, wherein the magnetic force generator is any one of a permanent magnet or a solenoid coil that has a polarity by an electronic signal.

8. The positive displacement clutch of claim 1, further comprising a magnetic force generator moving member connected with the magnetic force generator and moving the magnetic force generator along the output shaft so that the magnetic force generator is inserted into or drawn out of the clutch casing.

9. The positive displacement clutch of claim 1, further comprising an electrical signal controller applying an electrical signal to the magnetic force generator to give a polarity to the magnetic force generator.

10. A power transfer system including a positive displacement clutch and a positive displacement brake, the power transfer system comprising:
a positive displacement clutch of any one of claims 1 to 9; and
a positive displacement brake disposed on an output shaft corresponding to the clutch casing of the positive displacement clutch, with the magnetic fore generator therebetween,
wherein the positive displacement brake includes;
a brake disc disposed on the output shaft and having a plurality of disc vanes arranged with predetermined intervals around its outer side;
a brake casing housing the brake disc and having a plurality of sections in a cylinder divided by the disc vanes;
a piston actuator including a piston roller that rolls on the brake disc, and decelerating or braking the output shaft by applying a braking load to the brake disc, using compressive resistance between the piston roller and any one of the disc vanes and vacuum resistance between the piston roller and another one of the disc vanes; and
a magnetic member disposed in the brake casing, connected with the piston actuator, and operating the piston actuator in cooperation with the magnetic member.

11. The power transfer system of claim 10, wherein the clutch and the brake are operated by one magnetic force generator between the clutch and the brake.

12. A transmission system for changing a rotational speed of an input shaft connected with a power source into a desired rotational speed of an output shaft, the transmission system comprising:
a plurality of clutch discs arranged with predetermined intervals on the input shaft and having disc vanes arranged with predetermined intervals on their outer sides;
a plurality of clutch casings having different outer diameters, disposed on a driving shaft, housing the clutch discs, respectively, having teeth on their outer side, and having a plurality of sections in cylinders divided by the disc vanes;
a plurality of piston actuators formed on the clutch casings, having a piston roller that comes in contact with the clutch discs, and transmitting rotation of the clutch discs to the clutch casings or not, using compressive resistance between the piston rollers and any one of the disc vanes and vacuum resistance between the piston rollers and another one of the disc vanes;
a plurality of magnetic members disposed in the clutch casings and connected with the piston actuators;
a plurality of magnetic force generators disposed on the driving shaft between adjacent disc casings and operating the piston actuators by generating a magnetic force for acting with the magnetic members in the clutch casings; and
a plurality of gears disposed on the output shaft, rolling on the clutch casings, respectively, and having different outer diameters.

13. The transmission system of claim 12, wherein the magnetic force generators are permanent magnets generating a magnetic force or solenoid coils generating a magnetic force by an electrical signal.
